(19) United States
(12) Patent Application Publication
(10) Pub. No.: US 2018/0178500 A1
(43) Pub. Date: Jun. 28, 2018

(54) METHOD FOR BONDING HETEROGENEOUS SUBSTRATES

(71) Applicant: Pioneer Material Precision Tech Co., Ltd., New Taipei City (TW)

(72) Inventors: Te-Ning Chen, New Taipei City (TW); Jung-Hua Shen, New Taipei City (TW)

(21) Appl. No.: 15/585,500

(22) Filed: May 3, 2017

(30) Foreign Application Priority Data
Dec. 22, 2016 (TW) 105142604

(51) Int. Cl. B32B 37/10; B32B 38/00; B32B 37/06

(52) U.S. Cl. CPC B32B 37/10; B32B 2310/0831; B32B 37/06; B32B 38/0008

(57) ABSTRACT

A method for bonding heterogeneous substrates includes the steps of: applying ultraviolet radiation to a surface of a first substrate made of plastics, engineering plastics composite or a metal material;

adhering a second substrate raw material to the UV radiation treated surface of the first substrate, the second substrate raw material being fluorinated hydrocarbon rubber or silicone rubber; and press molding the first substrate and the second substrate raw material so as to bond the first substrate and a second substrate of the second substrate raw material together.

### CROSS-REFERENCE TO RELATED APPLICATION

This application claims priority of Taiwanese Patent Application No. 105142604, filed on Dec. 22, 2016.

### FIELD

The disclosure relates to a method for bonding substrates, and more particularly to a method for bonding heterogeneous substrates.

### BACKGROUND

A conventional protective shell for a portable electronic device (such as a mobile phone or a tablet computer) or a wearable device is usually a single-layered substrate, which is liable to deform and detach from the device. In addition, the opposite surfaces of the protective shell (i.e., the inner surface to be in contact with the device and the outer surface to be in contact with the user) are usually required to have different properties to meet various needs.

Currently, a surface treatment is applied to one of the surfaces of the single-layered substrate. However, the surface treatment is a complicated process and requires the use of many organic solvents. Moreover, the treated surface is usually very thin and likely to wear out after long-term use.

Another conventional protective shell is a double-layered structure manufactured by bonding two substrates made of different materials. The layers of such double-layered structure usually delaminate from each other due to friction.

### SUMMARY

Therefore, an object of the disclosure is to provide a method for bonding heterogeneous substrates that can alleviate at least one of the drawbacks of the prior art.

According to the disclosure, the method includes the steps of:

applying ultraviolet radiation to a surface of a first substrate made of plastics, engineering plastics composite or a metal material;

adhering a second substrate raw material to the UV radiation treated surface of the first substrate, the second substrate raw material being fluorinated hydrocarbon rubber or silicone rubber; and

press molding the first substrate and the second substrate raw material so as to bond the first substrate and a second substrate of the second substrate raw material together.

### DETAILED DESCRIPTION

Unless defined otherwise, all technical and scientific terms used herein have the meaning commonly understood by a person skilled in the art to which the present disclosure belongs.

One skilled in the art will recognize many methods and materials similar or equivalent to those described herein, which could be used in the practice of the present disclosure. Indeed, the present disclosure is in no way limited to the methods and materials described.

According to this disclosure, a method for bonding heterogeneous substrates includes the steps of:

applying ultraviolet radiation to a surface of a first substrate made of plastics, engineering plastics composite or a metal material;

adhering a second substrate raw material to the UV radiation treated surface of the first substrate, the second substrate raw material being fluorinated hydrocarbon rubber or silicone rubber; and

press molding the first substrate and the second substrate raw material so as to bond the first substrate and a second substrate of the second substrate raw material together.

In certain embodiments, the step of press molding the first substrate and the second substrate raw material is conducted by hot press molding. According to this disclosure, the hot press molding is conducted under a temperature ranging from 95° C. to 195° C. If the temperature of hot press molding is below 95° C., the second substrate raw material may not be completely cured, and the resultant second substrate may have mechanical properties (such as hardness, tensile strength, elongation, etc.) that are incapable of meeting industrial requirements. If the temperature of hot press molding is over 195° C., the second substrate raw material may be cured too quickly to completely and evenly cover the first substrate. In an exemplary embodiment of this disclosure, the hot press molding is conducted under a temperature ranging from 155° C. to 195° C.

In certain embodiments, the second substrate raw material is fluorinated hydrocarbon rubber.

Examples of the engineering plastics composite of the first substrate may include glass fiber reinforced polycarbonate (PC), carbon fiber reinforced PC, glass fiber reinforced polyamide (PA), carbon fiber reinforced PA, glass fiber reinforced polyphenylene sulfide (PPS), carbon fiber reinforced PPS, glass fiber reinforced polyetherimide (PEI), carbon fiber reinforced PEI, glass fiber reinforced polyethersulfone (PES), carbon fiber reinforced PES, and combinations thereof.

In certain embodiments, the first substrate is made of an alloy. Examples of the alloy suitable for use in this disclosure may include stainless steel, aluminum alloy containing magnesium and silicon (such as 6061 aluminum alloy), titanium alloy containing aluminum and vanadium (such as Ti-6A1-4V), nickel alloy containing copper or nickel alloy containing chromium, and combinations thereof.

According to this disclosure, the ultraviolet radiation is applied at a cumulative dose ranging from 5000 mJ/cm² to 25000 mJ/cm². When the cumulative dose of ultraviolet radiation is greater than 25000 mJ/cm², the ultraviolet radiation with such high dose may result in the deterioration of the first substrate and excess energy consumption. In certain embodiments, the ultraviolet radiation is applied at a cumulative dose ranging from 10000 mJ/cm² to 20000 mJ/cm².

In certain embodiments, after UV radiation, the UV radiation treated surface of the first substrate exhibits increased hydrophilicity.

In certain embodiments, the first substrate has a thickness ranging from 0.5 mm to 3.5 mm. In certain embodiments, the second substrate has a thickness ranging from 1 mm to 3 mm.

The disclosure will be further described by way of the following examples. However, it should be understood that the following examples are solely intended for the purpose of illustration and should not be construed as limiting the disclosure in practice.

### Bonding the Heterogeneous Substrates

### EXAMPLES 1-4

### E1-E4

A first substrate was irradiated with ultraviolet light (wavelength: from 100 to 400 nm) of a UV lamp having the illuminance of 210 mW/cm². The distance between the

UV lamp and a surface of the first substrate that is to be treated is 3 mm. The ultraviolet radiation is applied at a cumulative dose of 15,000 mJ/cm². The speed of a conveyor on a UV machine is 0.8 m/min.

A portion (50 mm×25 mm) of the UV radiation treated surface of the first substrate was coated with an coupling agent. After placing the coated first substrate in a mold cavity (having a height of 4 mm) of a mold, the mold cavity was filled with a second substrate raw material. In this embodiment, the second substrate raw material was adhered to the coupling agent-coated portion of the first substrate via the coupling agent. It should be noted that the second substrate raw material that was located at a position not corresponding to the coupling agent-coated portion of the first substrate was not adhered to the first substrate.

The second substrate raw material and the first substrate in the mold were subjected to a hot press molding process under 175° C., so as to cure the second substrate raw material to a second substrate and to bond the first substrate with the second substrate, thereby forming a double-layered L-shaped test sheet.

The first substrate, the second substrate raw material and the coupling agent used in Examples 1-4 are shown in Table 1.

TABLE 1

| | | Second substrate | Coupling |
|---|---|---|---|
| Example | First substrate | raw material | agent |
| E1 | Glass fiber reinforced | Fluorinated | Mixture of |
| | polycarbonate (PC) | hydrocarbon | Chemlok ® 607 |
| | containing 30% glass | (FKM) | and Chemlok ® |
| | fiber and having a | rubber material | Y1520A in a |
| | thickness of 2 ± | (commercially | weight ratio |
| | 0.02 mm | available from | of 7:3 (both |
| | (commercially | Dupont) | purchased |
| | available from Nan Ya | | from LORD |
| | Plastics Corporation, | | Corporation) |
| | Cat. No. 5210G6) | | |
| E2 | Fiber reinforced | | |
| | polyamide (PA) | | |
| | containing 50% glass | | |
| | fiber and having a | | |
| | thickness of 2 ± | | |
| | 0.02 mm | | |
| | (commercially | | |
| | available from Solvay, | | |
| | Cat. No. Kalix ® | | |
| | 9950) | | |
| E3 | Stainless steel having | | |
| | a thickness of 2 ± | | |
| | 0.05 mm | | |
| | (commercially | | |
| | available from Anshun | | |
| | Enterprise Co., Cat. | | |
| | No. SUS304) | | |
| E4 | Glass fiber reinforced | | |
| | polyphenylene sulfide | | |
| | (PPS) containing 40% | | |
| | glass fiber and having | | |
| | a thickness of 2 ± | | |
| | 0.02 mm | | |
| | (commercially | | |
| | available from | | |
| | TOSOH Corporation, | | |
| | Cat. No. GS-40) | | |

### EXAMPLES 5-8

### E5-E8

The test sheets of E5-E8 are made by procedures respectively similar to those of E1-E4, except that the second substrate raw material used in E5-E8 is a silicone rubber material (commercially available from Shin-Etsu Chemical Co., Ltd., Cat. No. KE951) and that the hot press molding procedure was performed under 115° C. In addition, the coupling agent used in E5 and E6-E8 are respectively ME153 and ME151 (commercially available from Momentive Performance Materials).

### CONTROL EXAMPLES 1-8

### C1-C8

The test sheets of C1-C8 are made by procedures respectively similar to those of E1-E8, except that the first substrate was not irradiated with ultraviolet light.

### COMPARATIVE EXAMPLE 1-8

### CE1-CE2

The test sheets of CE1 and CE2 are made by procedures respectively similar to those of E3 and E2, except that the second substrate raw material used in CE1 and CE2 is a nitrile butadiene rubber (NBR) material (commercially available from NANTEX Industry Co., Ltd., Cat. No. 1501).

### COMPARATIVE EXAMPLE

### CC1-CC2

The test sheets of CC1 and CC2 are made by procedures respectively similar to those of C3 and C2, except that the second substrate raw material used in CC1 and CC2 is a nitrile butadiene rubber (NBR) material (commercially available from NANTEX Industry Co., Ltd., Cat. No. 1501). Determination of the contact angle

The contact angle of the first substrate of each of E1-E4 was determined prior to and after the UV radiation. The result is shown in Table 2. The smaller the contact angle, the greater the hydrophilicity of the first substrate.

TABLE 2

Contact angle

| | Prior to the UV radiation | After the UV radiation |
|---|---|---|
| E1 | 79.87° | 52.73° |
| E2 | 58.18° | 30.26° |
| E3 | 59.40° | 46.34° |
| E4 | 79.38° | 23.45° |

It can be seen from Table 2 that the first substrate of each of E1-E4 has smaller contact angle after the UV radiation, indicating that the surface treated with the UV radiation has increased hydrophilicity.

### Adhesive Strength Test

Ten of the L-shaped test sheets of each example were placed at room temperature for more than 24 hours. To determine the adhesive strength between the first and second substrates of each of the L-shaped test sheets, the portion of the second substrate that was not adhered to the first substrate was stretched until the second substrate was fractured (but not separated from the first substrate) or was separated from the first substrate (but not fractured). It should be noted that the second substrate being fractured but not separated from the first substrate indicated the relatively strong adhesion between the first and second substrates. In contrast, the second substrate being separated from the first substrate but not fractured (i.e., separated test sheet) indicated the relatively weak adhesion between the first and second substrates. The separating ratio of each example shown in Table 3 is obtained by the following formula.

Separating ratio (%)=the number of the separated test sheet/the number of the total test sheet×100%.

TABLE 3

| | Separating | | Separating |
|---|---|---|---|
| | ratio (%) | | ratio (%) |
| E1 | 0 | C1 | 30 |
| E2 | 0 | C2 | 20 |
| E3 | 0 | C3 | 20 |
| E4 | 0 | C4 | 20 |
| E5 | 0 | C5 | 40 |
| E6 | 0 | C6 | 30 |
| E7 | 0 | C7 | 30 |
| E8 | 0 | C8 | 100 |
| CE1 | 30 | CC1 | 20 |
| CE2 | 30 | CC2 | 30 |

It can be seen from Table 3 that the separating ratio of each of Examples 1-8 are significantly lower as compared with that of Control Examples 1-8, indicating that the UV radiation can greatly enhance the adhesive strength between the first and second substrates. In addition, the Comparative Examples have no obvious difference in separating ratio from the Control Comparative Examples. The experimental results reveal that the second substrate raw material being NBR is more liable to be separated from the first substrate regardless of whether the UV radiation is performed or not.

In view of the foregoing, by selecting the material of the first and second substrates and by applying the ultraviolet radiation to the first substrate, the adhesive strength between the first and second substrates can be effectively enhanced, thereby avoiding the separation thereof.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for bonding heterogeneous substrates comprising the steps of:
applying ultraviolet radiation to a surface of a first substrate made of plastics, engineering plastics composite or a metal material;
adhering a second substrate raw material to the UV radiation treated surface of the first substrate, the second substrate raw material being fluorinated hydrocarbon rubber or silicone rubber; and
press molding the first substrate and the second substrate raw material so as to bond the first substrate and a second substrate of the second substrate raw material together.

2. The method of claim 1, wherein the step of press-molding the first substrate and the second substrate raw material is conducted by hot pressing molding.

3. The method of claim 2, wherein the step of press-molding is conducted under a temperature ranging from 95° C. to 195° C.

4. The method of claim 2, wherein the second substrate raw material is fluorinated hydrocarbon rubber.

5. The method of claim 4, wherein the hot pressing molding is conducted under a temperature ranging from 155° C. to 195° C.

6. The method of claim 1, wherein the engineering plastics composite is selected from the group consisting of glass fiber reinforced polycarbonate (PC), carbon fiber reinforced PC, glass fiber reinforced polyamide (PA), carbon fiber reinforced PA, glass fiber reinforced polyphenylene sulfide (PPS), carbon fiber reinforced PPS, glass fiber reinforced polyetherimide (PEI), carbon fiber reinforced PEI, glass fiber reinforced polyethersulfone (PES), carbon fiber reinforced PES, and combinations thereof.

7. The method of claim 1, wherein the first substrate is made of an alloy.

8. The method of claim 7, wherein the alloy is selected from the group consisting of stainless steel, aluminum alloy containing magnesium and silicon, titanium alloy containing aluminum and vanadium, nickel alloy containing copper, nickel alloy containing chromium, and combinations thereof.

9. The method of claim 1, wherein the ultraviolet radiation is applied at a cumulative dose ranging from 5000 mJ/cm² to 25000 mJ/cm².

10. The method of claim 1, wherein the first substrate has a thickness ranging from 0.5 mm to 3.5 mm.

11. The method of claim 1, wherein the second substrate has a thickness ranging from 1 mm to 3 mm.
